(19) United States
(12) Patent Application Publication
(10) Pub. No.: US 2009/0186693 A1
(43) Pub. Date: Jul. 23, 2009

(54) Interactive video game display method, apparatus, and/or system for object interaction

(75) Inventor: Michael Panoff, Austin, TX (US)

Correspondence Address: NORTHWEST IP LAW GROUP, P. O. BOX 3703, PORTLAND, OR, 97208-3703, US

(73) Assignee: Edge of Reality, Ltd., Austin, TX (US)

(21) Appl. No.: 12/005,657

(22) Filed: Dec. 26, 2007

(51) Int. Cl. A63F 13/00

(52) U.S. Cl. 463/31; 463/43

(57) ABSTRACT

Electronic display systems, apparatuses, and methodologies, and, in particular, interactive display methods, apparatuses, and systems for video games, or the like (220) with embodiments employing one or more altered-time indications (402) and/or context-appropriate interaction previewing (410).

### RELATED APPLICATIONS

This application is a nonprovisional of, and claims the benefit of priority from, U.S. Provisional Patent Application No. 60/876,956, filed Dec. 23, 2006, which is hereby incorporated by reference in its entirety.

### COPYRIGHT NOTICE

© 2007 Edge of Reality, Ltd. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR § 1.71(d), (e).

### TECHNICAL FIELD

The subject matter of the present application pertains to electronic graphical displays for video games or the like, and in particular, to providing an enhanced player experience in the identification, selection, and/or performance of available game play interactions.

### BACKGROUND

In the development of many video game programs, developers often try to produce a virtual game world that emulates real life as realistically as is practicable, given applicable cost constraints and the technological state of the art. This is especially true for video games classified as “live action games,” in which the characters are designed to look sufficiently realistic and not like cartoons.

In real life, at any moment an entity (e.g., person, animal, mechanical object, etc., to name but a few examples) can have a variety of interactions possible with any of several objects within the entity's reach and/or effective interaction range. Typically there is an equally wide variety of ways in which a real-life entity can initiate an interaction with surrounding objects. The entity can often make specific choices with respect to which objects the entity should or will interact, and what form of interaction the entity will elect to initiate.

When playing a video game, a player often controls one or more characters, such as avatars, digital personas, other virtual entities in the game world simulation using some hardware interface, such as a game system's controller device. Unfortunately, typical controllers have a relatively small number controls available with which the user can register inputs. This can force constraints on the number and/or types of interactions that the player can initiate on behalf of characters in a video game. In order to provide more interaction choices, games often allow or require the player to perform special input sequences, such as multiple or repetitive inputs, often in rapid succession or in a specified order. Such selections can be difficult to learn or remember, and they can be cumbersome for many players to execute. Requiring these types of user inputs via a typical controller can confuse or frustrate a player, or otherwise limit a player's ability to perform actions enjoyably in the game world. Often it takes players a significant amount of time to simply learn the types of moves, actions, skills, or interactions a character can even perform.

### SUMMARY

Many of the frustrations, anxieties, and the player confusion in operating a video game controller are often exacerbated by the fact that in many game simulations the player is often beset with numerous time constraints. Much like in real life, and often because many video games attempt to approximate real life in their virtual environment, the game play and action does not wait for the player to learn how to interact with the presented game world. Embodiments consistent with the present subject matter can encompass electronic display systems, apparatuses, and methodologies involving the same; and, in particular, interactive display methods, apparatuses, and systems for video games, or the like. Additionally, those skilled in the relevant arts will readily appreciate that the present subject matter can be applied in additional and/or alternative display applications and such other applications are equally within the scope of the present application.

The present subject matter can be embodied in various useful configurations. For example, one aspect disclosed in various embodiments herein can be directed to methods, systems, and apparatuses for facilitating a player of an interactive electronic video game in the identification and/or selection of one or more interactions between a character controlled by the player and one or more objects in the game world presented to the player through electronic rendering on a display device. In one embodiment of operability, through, at least in part, player interaction, the game world can be caused to enter an altered state with respect to normal run-time display. One embodiment of such a state can include an altered-time mode, whereby the player can obtain an enhanced playing experience through, at least in part, receiving distinct advantages with respect to opportunities made available for the player to ascertain and select from among various choices of interactions a controlled game character can be presented with at various instances and/or locations in the game world.

Another aspect of embodiments consistent with the present subject matter can also enhance the player experience and enjoyment of video game programs, at least in part, by presenting a player with a novel, innovative, and useful game mechanic for displaying a preview of an interaction available for the character in a direction indicated by the player. On example of such a preview can be embodied in a context-appropriate graphical display and/or other visual presentation. Of course, the discussion herein of any specific graphical display or visual presentation is presented only for illustrative purposes and is not meant to present limitations on the scope of the claimed subject matter.

Additional aspects and advantages of this invention will be apparent from the following detailed description of preferred embodiments, which proceeds with reference to the accompanying drawings.

### BRIEF DESCRIPTION OF THE DRAWINGS

FIG. 1 depicts a schematic view of a game system embodiment including a game console with an internal computer.

FIG. 2 is a block diagram of a computer embodiment such as that included in the game console embodiment of FIG. 1.

FIG. 3 illustrates an embodiment of a controller.

FIG. 4 illustrates an embodiment of a process flow implemented with systems of the present application.

FIG. 5 illustrates one embodiment of an interaction preview for an area lacking an interactive object with which the character can interact.

FIGS. 6A & 6B illustrate an embodiment of aiming toward alternative interactive objects for a character to take cover.

FIGS. 7A & 7B illustrate an alternative embodiment of aiming toward objects for cover.

FIGS. 8A & 8B illustrate an embodiment of aiming a character preview at other game characters.

FIGS. 9A-9D illustrate an embodiment of a display sequence previewing, selecting, and executing an interaction.

### DETAILED DESCRIPTION

Embodiments consistent with the present subject matter can encompass interactive electronic display arts and methodologies, and, in particular, interactive display methods, apparatuses, and systems for video games, or the like. Additionally, those skilled in the relevant art will readily appreciate that the present subject matter can be applied in additional and/or alternative display applications consistent with the present application and such other applications are equally within the scope of the appended claimed. To facilitate discussion, one or more embodiments disclosed below are presented in the context of video games; however the embodiments disclosed below are for illustrative purposes only. The scope of the present subject matter is not intended to be limited by or to the extent of the specific illustrative embodiments discussed herein.

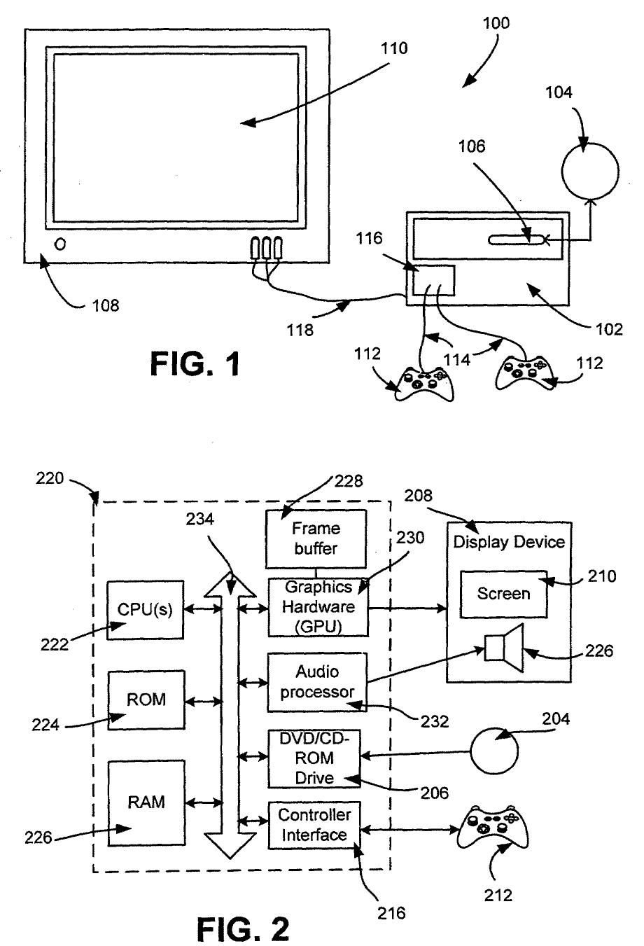

Continuing now with specific reference to the attached drawing figures, FIG. 1 illustrates an example of a typical video game system 100. Video game system 100 includes a game console 102 which can load a video game program stored on computer-readable medium 104, such a CD-ROM, DVD, or other forms of digital, optical, or magnetic storage media, through a designated receptor slot 106. Video game system 100 also can include a display device 108 having a display screen 110 for presenting graphical renderings caused by execution of the video game program. Display device 108 can be connected to console 102 by one or more audio/video or comparable analog or digital cables 118. Input devices, referred to as controllers 112 can be connected to console 102 wirelessly through a radio frequency communications interface, or via cables 114 connected to a plug or cable receptor port 116 on console 102. Controllers 112 can provide an interface for accepting operation commands from a player.

Internally, game console 102 includes a computer system for executing and implementing the video game program recorded and loaded into console 102 from medium 104. Display device 108 is configured to receive video and/or audio signals transmitted from console 102 during operation of the video game program. Graphical renderings output from console 102 are displayed in visual form on display screen 110 for viewing and interpretation by a player of the video game program.

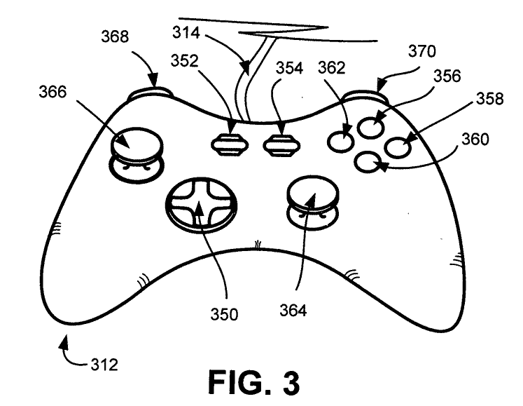

FIG. 2 depicts in greater detail, as a conceptual block diagram, some common components comprising and associated with a gaming platform, such as the video game computer system described as residing within console 102 of FIG. 1. With specific reference to FIG. 2, computer 220 comprises such components as one or more central processing unit (CPU) 222, a read only memory (ROM) 224 for storing a series of instructions and data required for CPU 222 to execute program instructions, a random access memory (RAM) 226 for temporarily storing the game program to be executed and the data used by the program and comprising a main memory, a graphic processing unit 230 (which can include graphics hardware such as chip cards and a graphics accelerator), an audio processor 232, a DVD, CD-ROM, or alternate drive 206 through which an appropriate program storage medium 204 can be loaded into computer 220. Computer 220 can also include a controller input/output interface component 216 coupled to a controller 212, and one or more system buses 234 connecting and interfacing between the various components of computer 220.

As conceptually illustrated through the various interconnections depicted in FIG. 2, a video game program can be loaded into computer 220 from a storage medium 204 through an appropriate interface or drive 206 applicable for the type of medium 204. Medium 204 stores (digitally, optically, magnetically, or otherwise) a video game program including instructions for computer 220 to use for execution of the program and handling of related data. Typically, drive 206 can read the video game program and corresponding data and store the same in RAM 226 for access by CPU 222. At runtime, CPU 222 can decode and execute video game program instructions stored in RAM 226 and control the circuits and components of computer 220 in accordance with the instructions and other input. CPU 222 can also control program execution so as to implement parts of the program executed in response to operational instructions input by a player on controller 212 through controller interface 216. CPU 222 can, in addition or in the alternative, execute instructions stored in ROM 224 when executing the program instructions.

Audio processor 232 can generate one or more audio signals based, at least in part, on audio data stored in RAM 226. Audio processor 232 can output the audio signal(s) to a speaker 226 integrated into display device 208, or another suitable audio projection device. Of course, the various components illustrated in FIG. 1 and FIG. 2 are presented for illustrative purposes only. The appended claims are in now way meant to be limited in application by the embodiments described above.

Graphics processor 230 can include video RAM (VRAM) and can include a frame buffer 228 inside. A three-dimensional (3D) image comprised of polygons can be drawing inside frame buffer 228 in response to one or more instructions from CPU 222. GPU 230 can generate a video signal in accordance with the image data stored in the frame buffer and outputs it to display device 208 for rending on display screen 210. In operation, 3D images are generated, or rendered, on via computer 220, typically using graphics acceleration hardware of GPU 230, in conjunction with RAM 226 and ROM 224 memory devices, which can store code and data structures related to the game world, such class information for player modules, interaction modules, camera modules and various environmental components of the 3D world, such as lighting, view points, and other information used to generate 3D images. The goal of the rendering operation is to produce in frame buffer 228 a 2D image that is to be displayed on display screen 210 of display device 208. 3D scenes are defined by a data structure commonly called a scene database. The scene database maintains models of objects in scenes of the game world, as well as information relating the objects to one another through predefined available interactions.

Additionally, throughout this description, discussions of a character in the video game, and the position and movement of the character, as well as that for the environment and objects in the environment, are to be understood to be referring to the data and data structures representing those elements of the game, as stored and manipulated by a game console or computer system, though, for brevity, the data, data structures, and their manipulation may not be explicitly referenced. Those skilled in the art will also readily appreciate that fewer, additional, and/or alternative components can be employed with respect to systems such as those described above without departing from the scope of the claimed subject matter.

Embodiments consistent with the present subject matter can encompass one or more of a variety of aspects and/or characteristics that can provide useful contributions to the video game arts by substantially enhancing the gaming experience for payers of applicable interactive video games or similar electronic graphical displays. Applicant has discovered that with the present state of the art in video games, especially with video games attempting to emulate real life, players are often beset with numerous time pressures and game play scenarios that demand rapid and accurate input of character operations. Unfortunately, such environments can be detrimental to may players' enjoyment of the video game. The subject matter of the present application affords players an enhanced and more enjoyable gaming experience whereby, at least in part, players are aided in identifying, exploring, and learning the types, availability, and/or selection of character interactions available.

Present embodiments can reduce, at least in part, one or more aspects of time pressures commonly felt by players. For example, in one such aspect, embodiments consistent with the claimed subject matter can display one or more forms of altered-time and/or dashing movements for one or more characters or objects. Such time modifications can benefit players by offering at least a partial temporal advantage to the player's character in the game world. Additionally enhancing the player experience, one or more embodiments can additionally or alternatively display context-appropriate interaction previews for a player to peruse. Such embodiments consistent with the claimed subject matter can substantially accommodate direct, interactive player inputs to enhance the participatory experience of the user, such as in an interactive video game, as but one example. Such embodiments also can be employed in a wide variety of video game displays, accommodating varied types of games or display perspectives (2-D, 3-D, etc.).

Embodiments consistent with the present subject matter can improve a player's experience by effectively offering an increased variety of interaction choices substantially without requiring a correspondingly increased number of player input controls on the controller or difficult input selection sequences. Context-appropriate previews can be provided to identify, illustrate, highlight, expound upon, and/or otherwise clarify one or more of the various interaction choices the player can have available at a given instant and/or location in the game world.

In one or more embodiments implemented consistent with the claimed subject matter, which are presented herein for illustrative purposes and for purposes of facilitating discussion, and not by way of limitation, a player can select one or more controls on a video game controller, as one example of a user-input device embodiment, to employ one or more gaming mechanics and/or display effects for a video game character under his or her control.

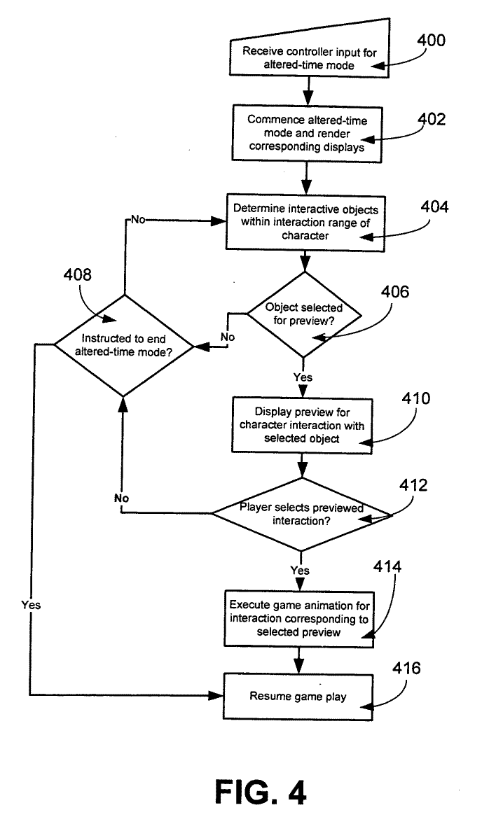

FIG. 3 illustrates a close up view of a controller embodiment, such as controller 112 of FIG. 1 and controller 212 of FIG. 2. With particular reference to FIG. 3, a controller 312 illustrated a common type and/or configuration of input device for use by a player to provide input to a gaming console via a plurality of buttons and/or other operating controls. For example, control 350 illustrates a directional key component, comprised of four directional keys for moving a cursor and/or other comparable graphical elements displayed on a screen in directions of left, right, up, and down, and/or combinations thereof. Control 352 and control 354 can be provided to offer additional functionality, such as for use as a select button, start button, pause button, etc. Control buttons 356, 358, 360, and 362 respectively illustrate examples of game specific function buttons, such as a first function button, a second function button, a third function button, and a fourth function button. Controls 364 and 366 depict examples joysticks such as a right stick and left stick, respectively. Controls 368 and 370 illustrate examples of buttons commonly referred to a left and right bumper, respectively. Additional and/or alternative input controls can also be included, but have been omitted from the embodiment of FIG. 3 for simplification. Additionally, the claimed subject matter is by no means dependent upon or limited by the specific embodiment of controller 312 of FIG. 3.

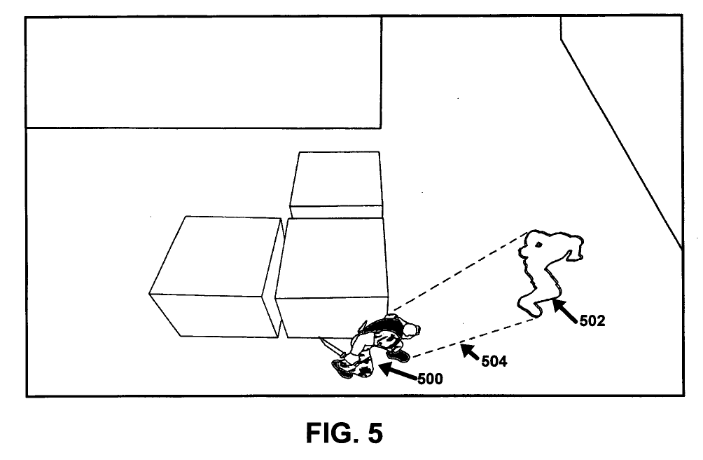

The following discussion includes illustrative embodiments of player input commands, selected character interactions, and various display elements of game mechanics, systems, apparatuses, and methodologies implemented in video gaming environments and related environments consistent with the claimed subject matter. Where applicable, the discussion will include references to the steps of the process flow diagram illustrated in FIG. 4 as but one embodiment of a methodology as can be presently implemented. It will be appreciated that additional and/or alternative steps have been omitted from FIG. 4 for purposes of simplifying discussion.

Beginning with reference to FIG. 4, an embodiment, such as the one illustrated, can begin at step 400, when a game system receives an input from a player to initiate a particular desired state and/or result in a video game program by selecting and engaging a predefined input control (e.g., such as pressing or pressing an holding a button or other control, such as left bumper 368 on controller 312 of FIG. 3, as but one example). In one embodiment, the selected state can correspond to an altered-time mode. In an altered time mode, time in the game world can be slowed, stopped, sped up, looped, or otherwise altered. This can be represented as illustrated in step 402 in FIG. 4, for example. In one embodiment, the altered-time mode can include slowing some modules (such as enemy characters) down to a small fraction of the true time step at which the simulation is running, while other modules (such as most low-level engine modules—e.g. sound thread servicing, game camera control, controller polling, file I/O, etc. can be left substantially unaffected by the slowed-down, altered-time mode simulation).

In one embodiment, the video game system can analyze neighboring objects within the a predefined and/or programmatically variable effective interaction range for the character being controlled by the player and select one or more context-specific interaction previews as appropriate for an object within the range and direction in which the player may interactively indicate. Step 404 of FIG. 4 illustrates this step. This process can also include objects that are not visually displayed or rendered on the screen, such ash those that are behind the character from the character's point of view and therefore not depicted on the screen.

In one embodiment, operation, generation, and maintenance of previews can be generally handled by character module or class, but position and pose data can be determined with reference to the interactive objects. For example, unlike environmental objects displayed in the game world, or usable objects, such as tools or guns, etc. interactive objects include animation data for predefined interactions with the character. When an altered-time state is entered, the character module can generate a list of all interactive objects in the applicable radius or area. If the player indicates a direction having an interactive object, the character module can use one or more virtual function calls to get the animation pose data and preview location data from the interactive object module. The preview location can be set with reference to character context as well. For example a ladder as an interactive object can provide a different interaction preview if the character begins a climb from the floor, than if the character begins a climb by jumping from an elevated platform. Of course, such implementations are described for illustrative purposes. Those skilled in the art will appreciate that many modified implementations can be employed while remaining consistent with the claimed subject matter.

Next, while in the selected altered-time mode, a player can select and employ a predefined input control (e.g., by using a controller input, such as a joystick, keypad, directional arrow buttons, or the like, such as left stick control 366 on controller 312 of FIG. 3, as but one example) to indicate a direction in which the player would potentially want the character in the video game to interact with one or more available objects. For each available direction the player can choose, a corresponding interaction can be previewed for the player. This step corresponds to Step 406 in FIG. 4. In alternative embodiments, other controls could also be used by the player for advantageous effect. For example, the right stick control 364 of controller 312 in FIG. 3 can be made available to manipulate the virtual camera controlling the virtual point of view displayed on the screen.

In one embodiment, in response to a player indicating a selected direction, a graphical representation of the player's character performing, at least in part, the applicable interaction can be displayed for the player. This representation can substantially provide the player with a preview of what would happen if the player accepts the interaction. Step 410 of FIG. 4 shows this step.

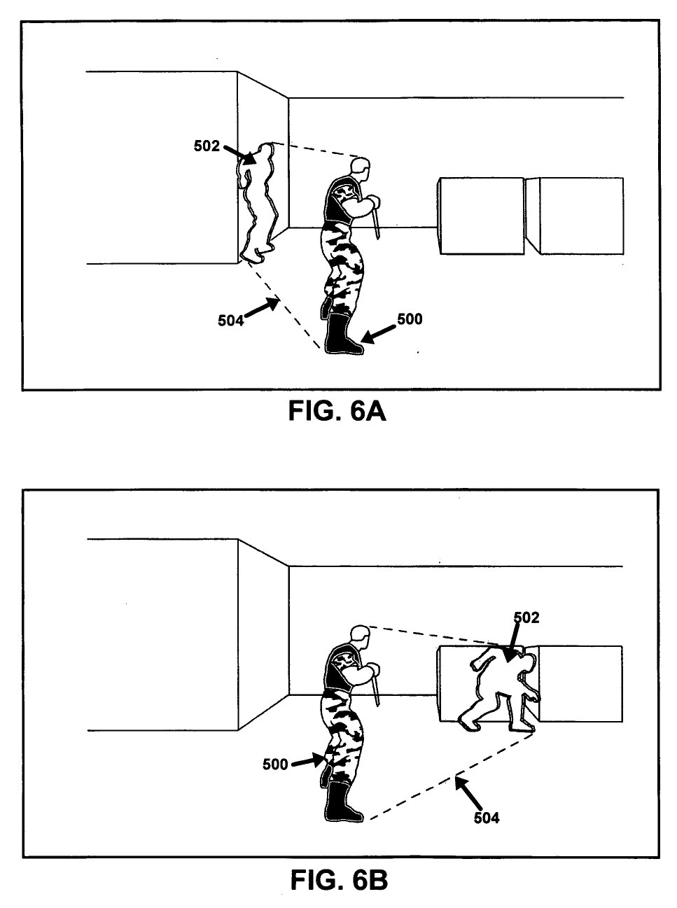

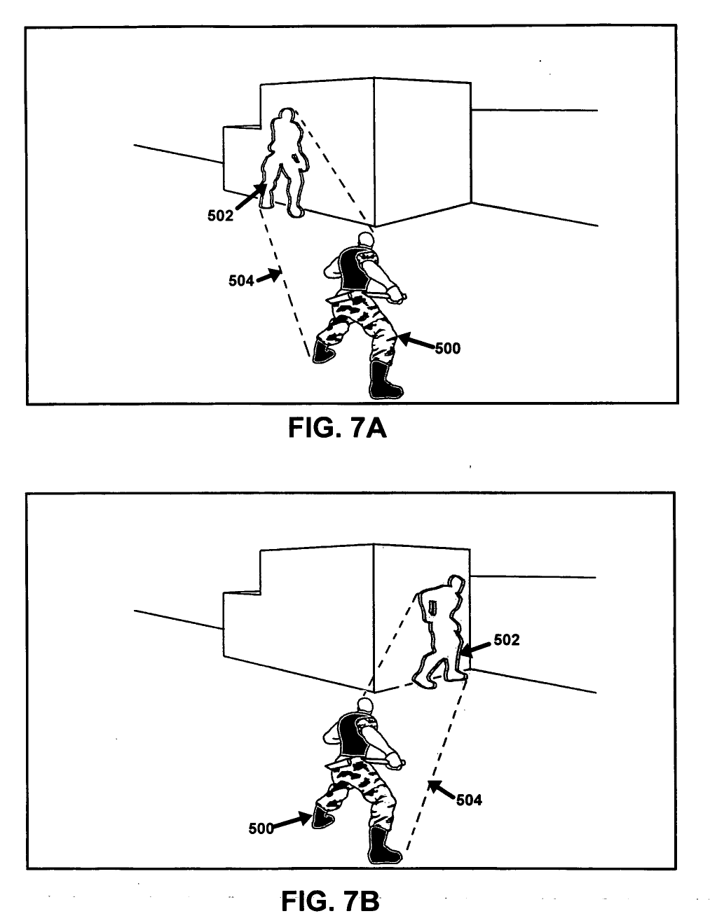

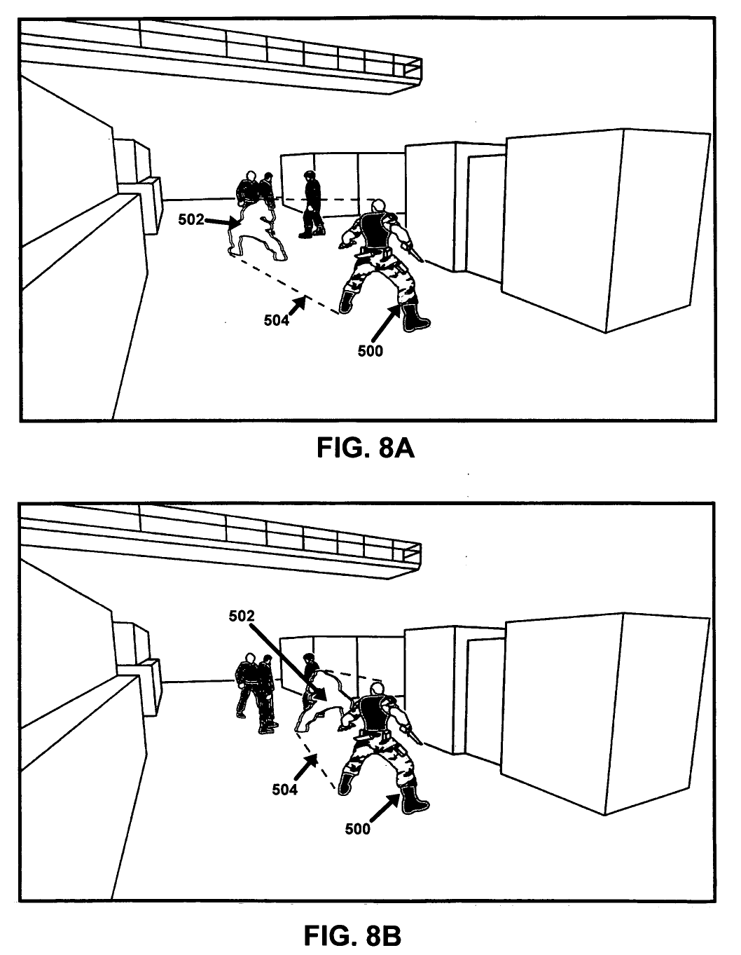

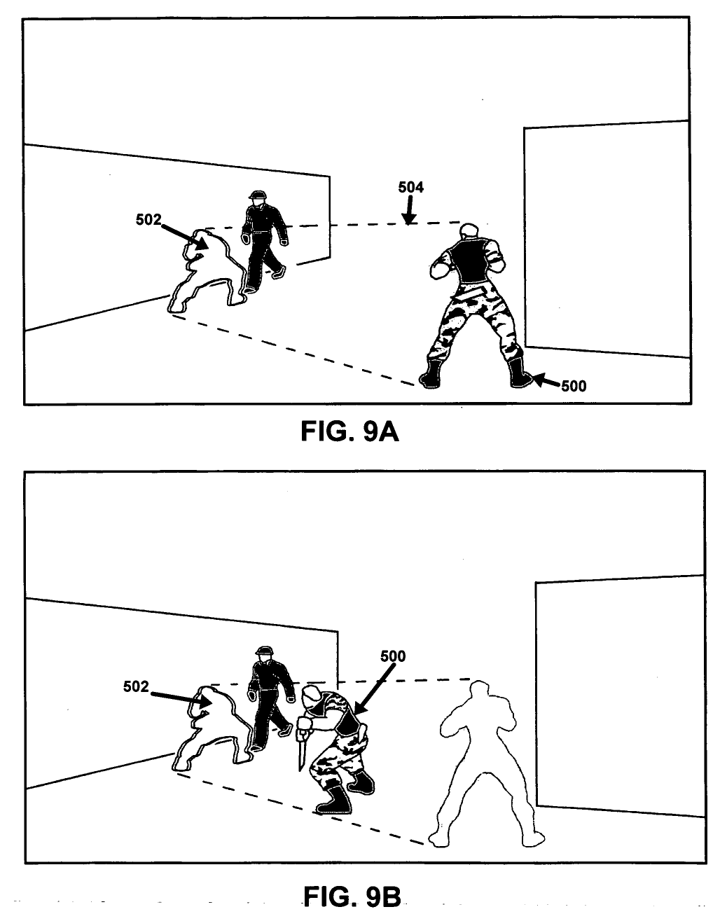

FIGS. 5, 6A, 6B, 7A, 7B, 8B, 9A, and 9B illustrate a few examples of screenshots depicting embodiments of context-appropriate interaction previews 502 Consistent with the present subject matter, a preview 502 can illustrate an interaction the player's character 500 would engage in if the player selected a particular interaction, without actually requiring the player to cause the character to take the particular action or substantially without requiring a corresponding advancement in game play and game time. This can be accomplished by maintaining an altered-time mode for the display during the player's preview process. This is represented by decision step 408 in FIG. 4. Objects in the game world, other than the player, can be held still, or reduced to slow-motion advancement, as discussed in more detail below. In one embodiment the preview can be displayed substantially proximate to an interactive object, and it can depict where, how, and/or in what capacity, etc. the player's character would interact with the object (e.g., positioning, action, etc.) if it were to actually perform the previewed action. Embodiments can change, vary, and/or otherwise alter and/or update the preview representation to reflect new interactions in response to the player selecting different directions.

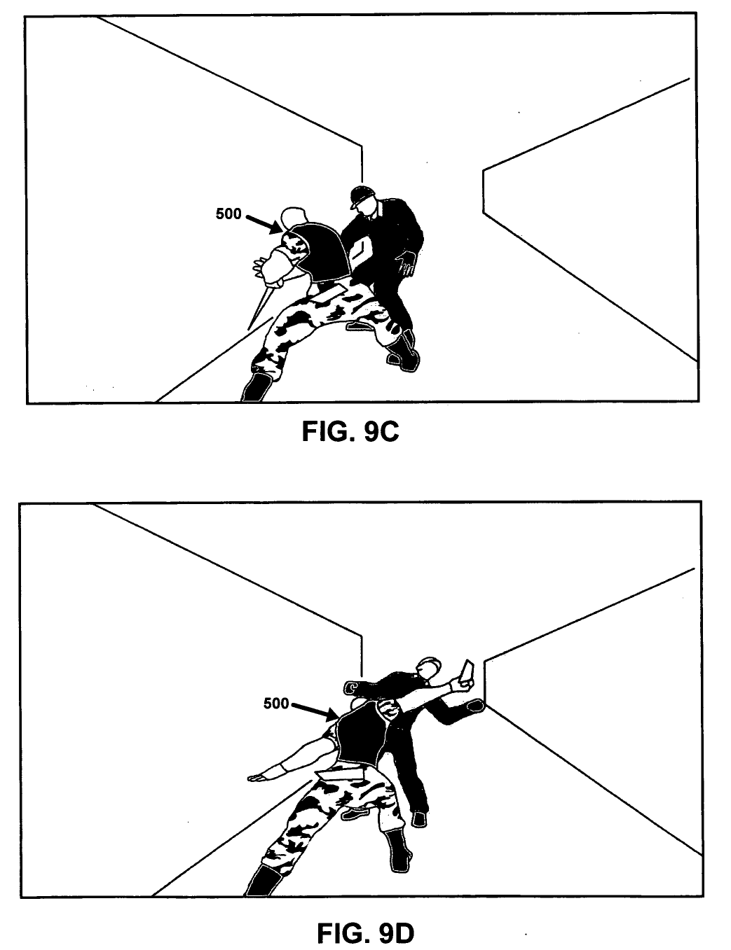

Next, as depicted in step 412 of FIG. 4, an embodiment consistent with the present subject matter can allow the player to choose an action using interactive control inputs (e.g., such as by pressing or releasing a button combined with aiming, as but one example) to select from among one or more previewed interactions. A player may also choose interactions or character actions that were not previewed. In one embodiment, in response to the player choosing an action in preview mode, game-time can be resumed at normal speed (e.g., exit altered-time mode, etc.), and the player's character can engage in the selected interaction. Steps 414 and 416 illustrate these steps. To speed up game play, and/or as another example of an altered-time mode implementation, the player's character can dash (e.g., be depicted as moving substantially rapidly, with respect to normal game-time movements) to the preview position to perform the intended interaction. FIGS. 9A through 9D illustrate one screen shot embodiments as examples of a character dashing to a position to execute a previewed interaction.

One benefit of enabling rapid locomotion of the character to the interaction site (which alternatively and/or additionally can include accelerated performance of the interaction itself) is in the context of dynamic interactive objects. When a player displays a preview, if the altered-time mode does not provide for dynamic objects (such as other people or living entities in the game world) to be frozen in time, there is a risk that they will be out of range or direction of the previewed interaction if the player does not perform the interaction soon enough. Enabling rapid movement of the character to perform the interaction addresses this concern and provides for an enhanced player experience, in that the player can be assured that an interaction that was just previewed should still be able to be performed.

In one embodiment the interactive preview distance can encompass a specific radius or other distance away from the player's character. This value can be predetermined or it can vary based on game context. With such embodiments, a player can peruse for interactive objects by sweeping some or all of a 360-degree circle around the character's location. if the player selects a direction without any objects within the effective range of the player's character, with reference and due consideration given to the game context, the preview can depict the player's character on open ground in the direction that the player aims. In addition, or as an alterative, the interaction preview can be depicted so that the type/extend of available interaction appears to be reduced or eliminated entirely, etc. In this context, interactions are properly defined to include the absence of specific interaction with one or more interactive objects. If the player performs the dash in a direction with no objects, one embodiment of a video game system can allow game play to exit the altered-time mode, and the player can dash to the preview location but substantially avoid performing any particular interactions (e.g., no particular animation shown). This is an example of an previewed interaction that does not include interaction with an interactive object.

Consistent with the present subject matter, one or more embodiments can allow the player, depending on what input the player provides (e.g., which input control is pressed or released, etc.), to choose to remain in altered-time mode. In one such embodiment, after performing the first interaction in normal time, time can, without requiring further player input, slow, stop, and/or otherwise enter the altered-time mode, and a second set of previews can be selected for displayed.

An embodiment can enable a player to cancel an interaction preview by providing a particular input (e.g., such as pressing or releasing a button without aiming a directional controller, as but one example). In response to receiving such a predefined input, a preview can be cancelled and time can resume at a normal rate. If an interaction is canceled by the user, the player's character need not dash to any objects or perform any corresponding interactions (e.g., a response to an absence of a selection to which a response is required).

In one embodiment, described for illustrative purposes and not by way of limitation, an altered-time mode can encompass a slow-motion effect. For example, during normal game-play, the game world can be rendered by the video game system several times per second, usually 30 or 60, although other quantities could also be selected. If the game is rendered at 60 frames per second, as but one example of emulating “real time” in the simulated game world, time in the simulated world advances by 1/60 of a second in every successive frame. An embodiment depicting slow motion time as an altered-time mode can display the desired effect by updating or rendering the world simulation display at less than the normal rate (e.g., less that 1/60 of a second, etc.). As another example of an altered-time mode, an embodiment can depict stopped time. To depict stopped time, an embodiment can elect not to update the world simulation time. Those skilled in the art will appreciate that additional and/or alternative forms of altered-time displays can also be employed consistent with the present subject matter. One such example could include looped time, using a memory location to reverse executed animations.

In one embodiment, when a game enters an altered-time mode, the player's character can be displayed as remaining in substantially the same position it was in prior to entering the altered-time mode. In addition to the primary graphical representation of the player's character, a secondary representation of the player's character can be displayed representing or corresponding to the preview. One or more embodiments can depict a secondary representation of the player's character using a pose from a frame, or full or partial sequence of frames, from the animation data of the specified interaction. Such embodiments can allow the preview to provide a substantially accurate representation of the actual interaction, were it to be chosen by the player. For clarity, the secondary representation of the character drawn for the preview can employ a different rendering style, in order to distinguish it from the primary character representation. For example, in FIGS. 5-9D, the primary representation of the character 500 is depicted as a 3-D person. The secondary representation or preview 502, however, is illustrated as an outline of the character previewing the intended action. Color coding can also be used, in addition, or in the alternative, with the displayed interaction previews. Embodiments can employ different colors to signify different types of interactions or alternative styles of interaction available with an interactive object. For ease of tracking, a trial or some other graphical indication linking the character representation 500 and the preview 502 can be rendered, such as the shadow effect 504 illustrated in the screen shots of FIGS. 5-9D.

It will be obvious to those having skill in the art that many changes may be made to the details of the above-described embodiments without departing from the underlying principles of the invention. The scope of the present invention should, therefore, be determined only by the following claims.

1. A method for facilitating a player of an interactive electronic video game in identifying and selecting an interaction between a character controlled by the player and one or more objects in a game world rendered on a display device, the method comprising:
in response to a first input from the player with the character at a location within the game world, implementing an altered-time mode; and
in response to a second input from the player, the second input indicating a direction from the character location, displaying a preview of an available interaction for the character in the indicated direction, the preview being displayed, at least in part, consistent with a context of the game world in the indicated direction.

2. The method of claim 1, wherein:
the context of the game world includes the absence of an interactive object within an interaction range of the character in the indicated direction; and
the preview of the available interaction represents movement of the character in the indicated direction.

3. The method of claim 1, wherein:
the context of the game world includes the presence of an interactive object within an interaction range of the character in the indicated direction; and
the preview of the available interaction is based, at least in part, on animation data for rendering an interaction between the character and the interactive object.

4. The method of claim 3, wherein the preview includes a character pose from a frame of the animation data for the interaction.

5. The method of claim 3, wherein the preview includes an outline of a character pose from a frame of the animation data for the interaction.

6. The method of claim 3, wherein the preview includes a partially transparent character pose from a frame of the animation data for the interaction.

7. The method of claim 3 wherein the preview is displayed having at least one of one or more predetermined colors, and each of the one or more predetermined colors indicates that the available interaction is of a corresponding one or more classes.

8. The method of claim 3, wherein the preview includes a textual display to provide the player with information about the available interaction.

9. The method of claim 1, wherein the altered-time mode emulates a slow-motion effect for one or more objects potentially available for interaction with the character.

10. The method of claim 9, wherein the slow-motion effect includes reducing a first frequency of animation frame updates for the one or more objects relative to a second frequency of animation frame updates for the character.

11. The method of claim 1, wherein the altered-time mode emulates stopped time for the one or more objects.

12. The method of claim 11, wherein stopped time is emulated by not updating a game world simulation time for the one or more objects.

13. The method of claim 1, further comprising:
in response to a third input from the player, the third input selecting the displayed preview, causing the character to perform the previewed interaction.

14. The method of claim 13, wherein the character performs the previewed interaction in an accelerated time step.

15. The method of claim 13, wherein:
the character is displayed as traveling from the character location to a location of previewed interaction in an accelerated time;
upon the character reaching the location of the previewed interaction, the altered-time mode is terminated and the character is displayed performing the previewed interaction with in normal time for the game world simulation.

16. The method of claim 1, further comprising: in response to the user indicating a next direction from the character location, displaying a next preview of a next available interaction for the character in the indicated next direction, said next preview being displayed, at least in part, consistent with a next context of the game world in the indicated next direction.

17. A computer system for allowing the player of an interactive video game program to select an interaction from among a plurality of potential interactions for display on a display device, the system implementing instructions of the program to:
during game play, receive, via a controller device, a player input requesting implementation of an altered-time mode of display for a plurality of interactive objects;
during the altered-time mode, enable the player to display, for each of the plurality of interactive objects, a preview of an available interaction between a character controlled by the player and the interactive object; and
implement an interaction animation corresponding to a preview selected by the player from among the displayed previews.

18. The system of claim 17, wherein each of the one or more previews is determined for interactive objects located within an effective interaction range of the character.

19. The system of claim 17, wherein the preview is based at least in part on game animation data stored in memory for use in rending a display of the interaction between the character and the interactive object on the display device.

20. The system of claim 19, wherein the preview includes displaying at least a portion of the game animation for the interaction corresponding to the selected preview.

21. The system of claim 20, wherein the program further causes the system to exit altered-time mode before implementing the game animation for the interaction corresponding to the selected preview.

22. The system of claim 17, wherein the previews are displayed in response to player input commands received via the controller device.

23. The system of claim 17, wherein the previews of the interactions are based, at least in part, on:
the class of interactive object; and
the position of the character during the altered-time mode.

24. Machine readable media having stored thereon a program to be executed by an interactive electronic video game system, the program being configured to cause the system to:
in response to receiving a first input from a first control of a player controller, implementing an altered-time mode for the display of one or more interactive objects;
in response to receiving one or more instances of a second input from a second control of the player controller during the altered-time mode, displaying a corresponding one or more interaction previews, each preview indicating an available action between a player character and at least one of the one or more objects; and
in response to receiving a third input from the player controller, the third input indicating a selection by the player of one of the displayed one or more interaction previews, concluding the altered-time display mode and resuming game play by displaying, in normal simulation time, animation data for the interaction corresponding to the selected preview.

25. The media of claim 24 wherein implementing the altered-time mode includes rendering a display of one or more interactive objects in an emulated slow-motion effect.
